(19) United States
(12) Patent Application Publication
(10) Pub. No.: US 2015/0070837 A1
(43) Pub. Date: Mar. 12, 2015

(54) HEAT-DISSIPATING DEVICE FOR INTERFACE CARD

(71) Applicant: COOLER MASTER CO., LTD., New Taipei City (TW)

(72) Inventors: WEN-CHUN HSU, NEW TAIPEI CITY (TW); TSUNG WEI LIN, NEW TAIPEI CITY (TW)

(21) Appl. No.: 14/458,425

(22) Filed: Aug. 13, 2014

(30) Foreign Application Priority Data
Sep. 9, 2013 (TW) 102216911

(51) Int. Cl. G06F 1/20

(52) U.S. Cl. CPC G06F 1/20
USPC 361/679.47

(57) ABSTRACT

A heat-dissipating device for interface card is disposed on an interface card. The heat-dissipating device includes a heat sink, a housing, and a fan. The heat sink is disposed on the interface card. The housing is disposed on the heat sink. The housing has a top plate and two side plates connected to the top plate. The top plate has an inlet opening. An inner surface of the top plate proximate to the inlet opening has a protruding wall and an opening. The protruding wall has a curve panel. The fan is arranged in the housing and correspondingly arranged at the inlet opening. The fan has a rotational shaft, a plurality of axial fan blades, and centrifugal fan blades. The rotational shaft is pivotally disposed on a bottom seat. The assembled heat-dissipating device can optimize air flow to improve heat dissipation and effectively improve heat dissipating rate.

### BACKGROUND OF THE INVENTION

1. Field of the Invention

The instant disclosure relates to a heat-dissipating device for interface card; in particular, to a heat-dissipating device that improves head dissipation efficiency for interface card.

2. Description of Related Art

A chip-typed Integrated circuit is typically applied to a computer via interface cards such as a display card, PCI card, AGP card, TV tuner, etc, in which the operating center of the chip tends to generate high temperature heat. Essential elements, such as display cards, convert electronic signals into images. The VGA chip in the display card is the heart of all the operational execution in a display card and directly processes the commands sent from software to produce images onto a display. Since image files are quite large in size, in order to immediately display the images in a short amount of time, the VGA chip has to rapidly read image data that can generate high temperature heat. Thus, the VGA chip of the display card needs highly efficient heat dissipation to maintain the VGA chip below critical operational temperature.

Conventional heat dissipation devices for interface cards include a heat sink assembled on the outer surface of the chip and a fan assembled outside the heat sink and directed towards the heat sink in order to improve air convention, but since the direction of air flow is difficult to control, air flow tends to randomly flow and escape through open areas between the heat sink and the interface cards, thus neglecting the efficiency of heat dissipation provided.

To address the above issues, the inventor strives via associated experience and research to present the instant disclosure, which can effectively improve the limitation described above.

### SUMMARY OF THE INVENTION

The objective of the instant disclosure is to provide a heat-dissipating device for interface card that can effectively improve heat dissipating efficiency.

In order to achieve the aforementioned objectives, according to an embodiment of the instant disclosure, a heat-dissipating device for interface card is provided. The heat-dissipating device is disposed on an interface card. The interface card has a circuit board and a heating element disposed on the circuit board. The heat-dissipating device includes a heat sink, a housing, and a fan. The heat sink has a plurality of heat dissipating fins and a plurality of heat pipes. The heat sink is disposed on the interface card and the heat sink is in contact with the heating element. The housing is disposed on and covers the heat sink. The housing has a top plate and two side plates connected to two sides of the top plate. The top plate has an inlet opening arranged thereon. An inner surface of the top plate proximate to the inlet opening has a protruding wall and an opening arranged thereon. The protruding wall has a curve panel. The fan is arranged in the housing and correspondingly arranged at the inlet opening. The fan has a rotational shaft, a plurality of axial fan blades, and a plurality of centrifugal fan blades. The axial fan blades are connected to an outer edge of the rotational shaft. The centrifugal fan blades are respectively connected to outer edges of the axial fan blades. The rotational shaft is pivotally disposed on a bottom seat.

In order to achieve the aforementioned objectives, according to another embodiment of the instant disclosure, a heat-dissipating device for interface card is provided. The heat-dissipating device for interface card is disposed on an interface card. The heat-dissipating device includes a heat sink, a housing, and a fan. The heat sink is disposed on the interface card. The housing is disposed on and covers the heat sink. The housing has a top plate and two side plates connected to two sides of the top plate. The top plate has an inlet opening arranged thereon. An inner surface of the top plate proximate to the inlet opening has a protruding wall and an opening arranged thereon. The protruding wall has a curve panel. The fan is arranged in the housing and correspondingly arranged at the inlet opening. The fan has a rotational shaft, a plurality of axial fan blades, and a plurality of centrifugal fan blades. The rotational shaft is pivotally disposed on a bottom seat.

In order to achieve the aforementioned objectives, according to another embodiment of the instant disclosure, a heat-dissipating device for interface card is provided. The heat-dissipating device for interface card is disposed on an interface card. The heat-dissipating device includes a heat sink, a housing, and a fan. The heat sink is disposed on the interface card. The housing is disposed on and covers the heat sink. The housing has a top plate and two side plates connected to two sides of the top plate. The top plate has an inlet opening arranged thereon. An inner surface of the top plate proximate to the inlet opening has a protruding wall and an opening arranged thereon. The fan is arranged in the housing and correspondingly arranged at the inlet opening. The fan has a rotational shaft, a plurality of axial fan blades, and a plurality of centrifugal fan blades. The rotational shaft is pivotally disposed on a bottom seat.

The instant disclosure provides the following improvements. The fan in the instant disclosure is a composite fan, which provides both axial and centrifugal flow. The housing has protruding walls and openings arranged thereon that can prevent unrestrained air flow as well as guide air to flow along the protruding walls and eventually towards the heat sink via the openings. The instant disclosure optimizes air flow, improve heat dissipation, and effectively improve heat dissipation efficiency.

Furthermore, the instant disclosure further provides protruding walls that include pressing portions on the housing. When air flows along the protruding walls and exits through the openings, air is pressurized and air flow is optimized to improve heat dissipation.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an exploded view of a heat-dissipating device for interface card in accordance with a first embodiment of the instant disclosure;

FIG. 2 is another exploded view of the heat-dissipating device for interface card of FIG. 1 in accordance with the instant disclosure;

FIG. 3 is an assembled view of the heat-dissipating device for interface card of FIG. 1 in accordance with the instant disclosure;

FIG. 4 is an exploded view of the heat-dissipating device for interface card in accordance with a second embodiment of the instant disclosure;

FIG. 5 is another exploded view of the heat-dissipating device for interface card of FIG. 4 in accordance with the instant disclosure;

FIG. 6 is an exploded view of the heat-dissipating device for interface card in accordance with a third embodiment of the instant disclosure;

FIG. 7 is another exploded view of the heat-dissipating device for interface card of FIG. 6 in accordance with the instant disclosure;

FIG. 8 is an assembled view of the heat-dissipating device for interface card of FIG. 6 in accordance with the instant disclosure;

FIG. 9 is an exploded view of the heat-dissipating device for interface card in accordance with a fourth embodiment of the instant disclosure;

FIG. 10 is another exploded view of the heat-dissipating device for interface card of FIG. 9 in accordance with the instant disclosure;

FIG. 11 is an exploded view of the heat-dissipating device for interface card in accordance with a fifth embodiment of the instant disclosure;

FIG. 12 is another exploded view of the heat-dissipating device for interface card of FIG. 11 in accordance with the instant disclosure;

FIG. 13 is an assembled view of the heat-dissipating device for interface card of FIG. 11 in accordance with the instant disclosure;

FIG. 14 is an exploded view of the heat-dissipating device for interface card in accordance with a sixth embodiment of the instant disclosure;

FIG. 15 is another exploded view of the heat-dissipating device for interface card of FIG. 14 in accordance with the instant disclosure.

### DETAILED DESCRIPTION OF THE PREFERRED EMBODIMENTS

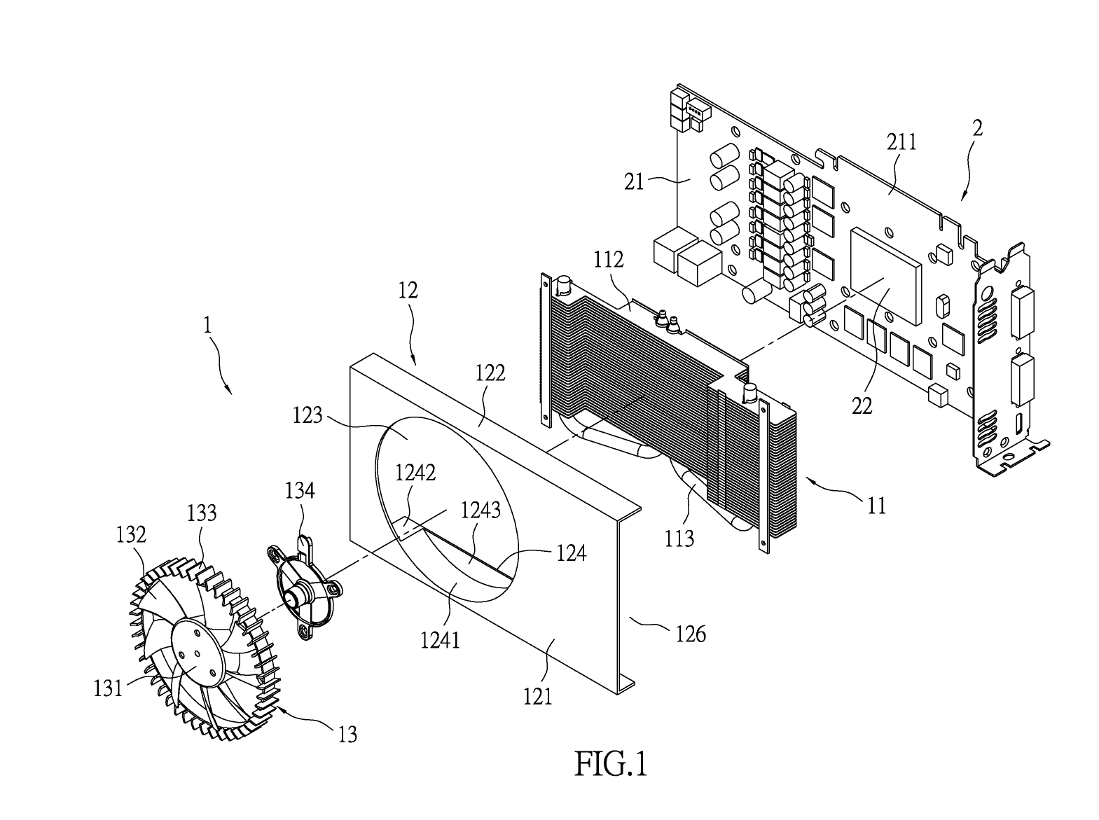

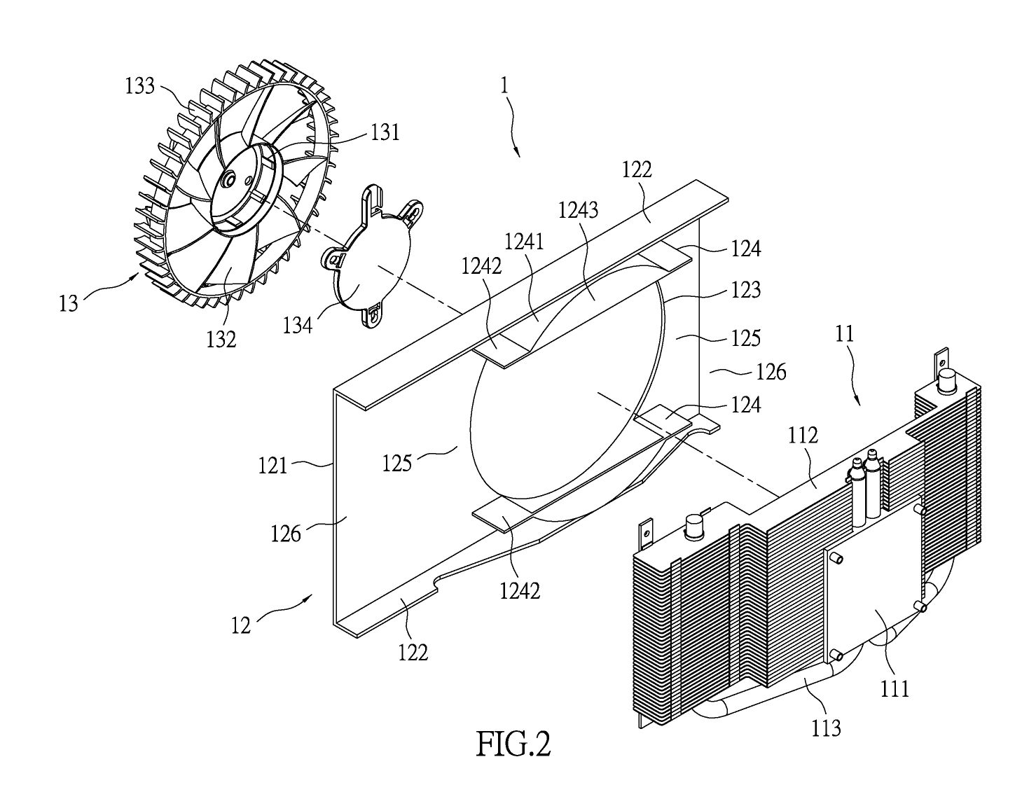

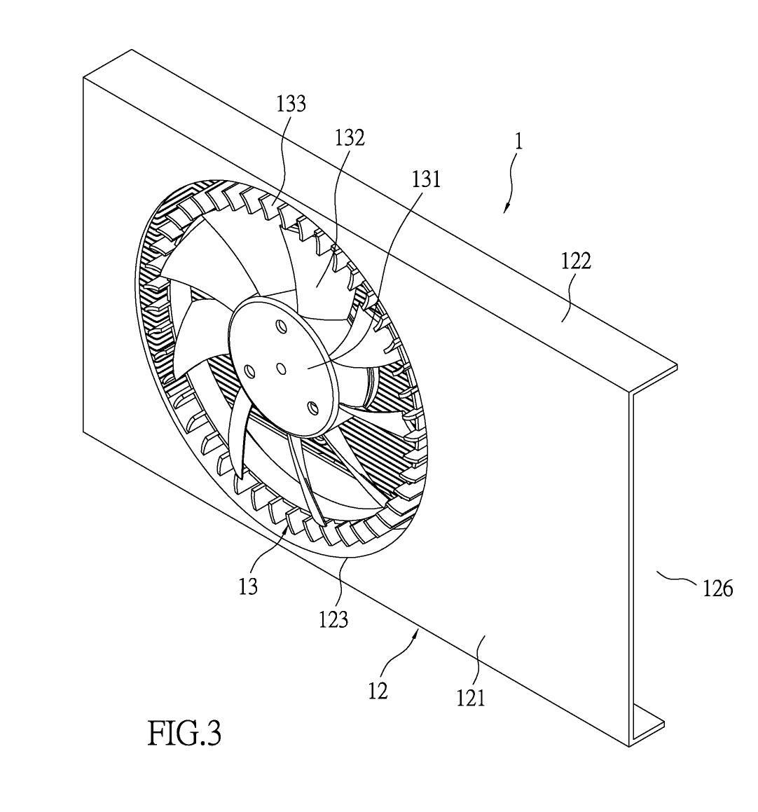

Please refer to FIGS. 1 to 3. The instant disclosure provides a heat-dissipating device for interface card 1, the interface card heat-dissipating device 1 is assembled on an interface card 2 (as shown in FIG. 1). The interface card 2 has a circuit board 21 and a heating element 22 disposed on the circuit board 21. The heating element 22 can be a wafer that heats up. A side edge of the circuit board 21 has an electrical connection 211. The interface card 2 can be a display card, sound card, graphics card, or network card. One heating element 22 is provided in the instant embodiment, but it is not limited thereto.

The heat-dissipating device 1 includes a heat sink 11, a housing 12 and at least one fan 13. The heat-dissipating device 11 is disposed on the heat sink 2. The heat sink 22 can include a heat conductive block 111, a plurality of heat-dissipating fins 112 and a plurality of heat pipes 113. The heat conductive block 111 can be attached on the heating element 22 at a bottom surface of the heating conducting block 111, such that the heat-dissipating device 11 and the heating element 22 are in contact. The heat dissipating fins 112 is arranged in parallel and spaced apart from the heat conductive blocks 111. The heat pipes 113 are arranged through the heat-dissipating fins 112 and are in contact with the heat conductive blocks 111. As a result, heat generated from the heating element 22 can be transferred to the heat-dissipating fins 112 via the heat conductive blocks 111, and the heating element 22 can rapidly transfer heat to the heat-dissipating fins 112 having relatively large surface areas for heat-dissipation process thereafter.

The housing 12 covers and is arranged on the heat sink 11. The housing 12 has a top plate 121 and two side plates 122 connected to the top plate 121. The two side plates 122 are bend extensions of the top plate 121 that bends from two opposite sides of the top plate towards the interface card 2. The heat-dissipating fins 112 can be in parallel with the two side plates 122 of the housing 12. The top plate 121 has an inlet opening 123 arranged thereon. The inlet opening 123 is arranged at a position corresponding to the fan 12 and the number of inlet opening 123 also corresponds to that of the fan 12. In the instant embodiment, one fan 13 and one inlet opening 123 are provided. An outlet opening 126 is formed between two oppositely arranged sides and the two side plates 122 of the top plate 121.

The top plate 121 has an inner surface. The inner surface proximate to the inlet opening 123 has a protruding wall and an opening 124 arranged thereon. The number and location of the protruding wall 124 are not limited thereto. There are two protruding walls 124, for example, arranged proximate to the inlet opening 123 in the instant embodiment. The protruding walls 124 are oppositely arranged and are located between the two side plates 122. The number and location of the opening 125 are not limited thereto. There are two openings 125, for example, arranged between two ends of two protruding walls 124 in the instant embodiment. The openings 125 are oppositely arranged and preferably correspond to one end of the heat pipes 113 to conduct heat away therefrom.

The structure of the protruding wall 124 is not limited thereto. In the instant embodiment, each protruding wall 124 has a curve panel 1241. The curve panel 1241 is extended along peripheral portions of the inlet opening 123. The curve panel 1241 and the inlet opening 123 can be concentric. Two ends of the curve panel 1241 each have an end plate 1242 formed thereon. The opening 125 is arranged between two opposite end plates 1242. The end plates 1242 and the two side plates 122 can be arranged in parallel, such that air flow can be guided towards two lateral sides of the housing 12. The curve panel 1241 can be connected to a bottom plate 1243 that is arranged at a bottom portion thereof. The curve panel 1241 and the top plate 121 are in parallel.

The fan 13 is arranged in the housing 12 and correspondingly arranged at the inlet opening 123. Each fan 13 has a rotational shaft 131, a plurality of axial fan blades 132, and a plurality of centrifugal fan blades 133. The axial fan blades 132 are spaced apart from each other, and the centrifugal fan blades 133 are connected to peripheral portions of the rotational shaft 131. The centrifugal fan blades 133 are spaced apart from each other and are connected to peripheral portions of the axial fan blades 132. The rotational shaft 131 is pivotally disposed on a bottom seat 124 to form a composite fan that provides axial and centrifugal air flow. The bottom seat 124 of the fan 13 can be screw locked or fixed on the heat sink 11 through other manners. When the fan rotates, cool or cold air can be drawn from the exterior and into the interior of the housing 12 via the inlet opening 123 and subsequently exits the outlet opening 126, in the meantime, heat from the heat dissipating fins 112 can be transferred out of the housing 12 via convection.

Specifically, the fan 13 has axial fan blades 132 and centrifugal fan blades 133. When the fan 13 rotates, cool or cold air can be drawn from the exterior and into the interior of the housing 12, subsequently flow along the axial and radial directions towards the heat dissipating fins 112, and flow past the heat dissipating fins 112 and exit through the outlet opening 126 in order to transfer heat from the heat dissipating fins out of the housing 12 via convection.

### Second Embodiment

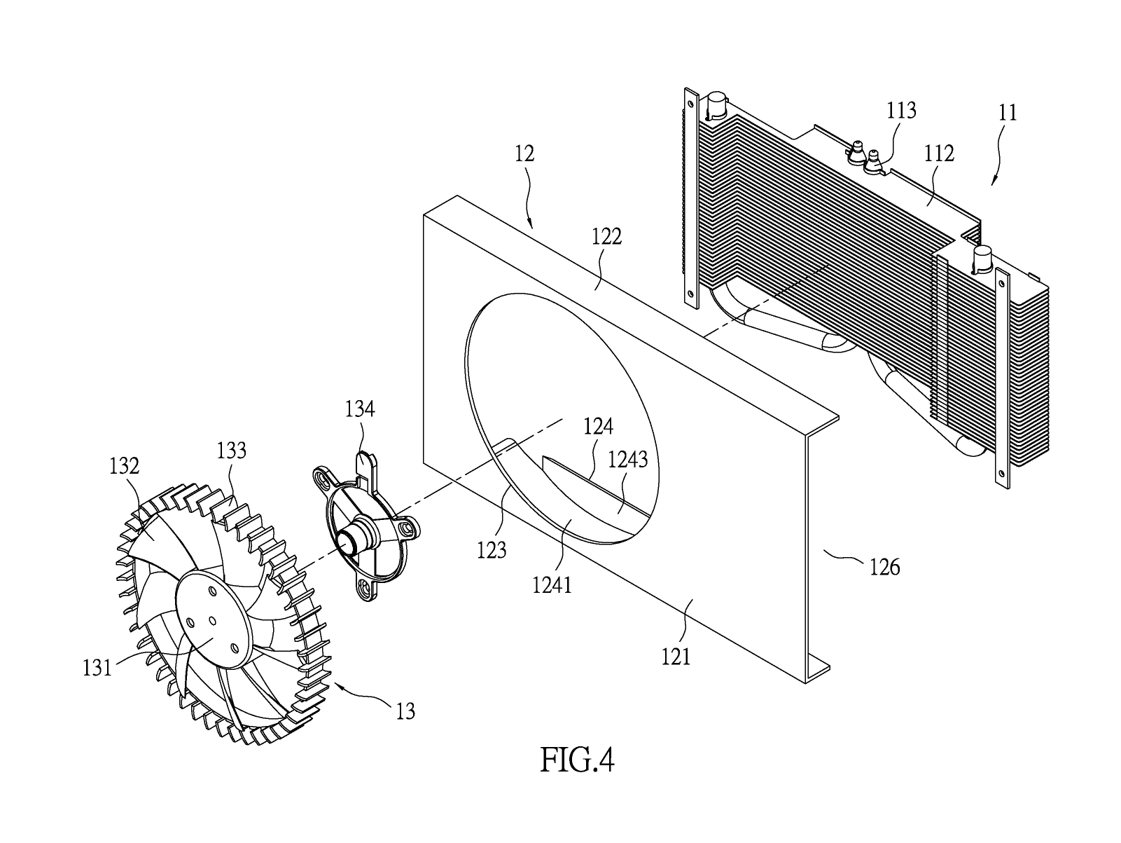

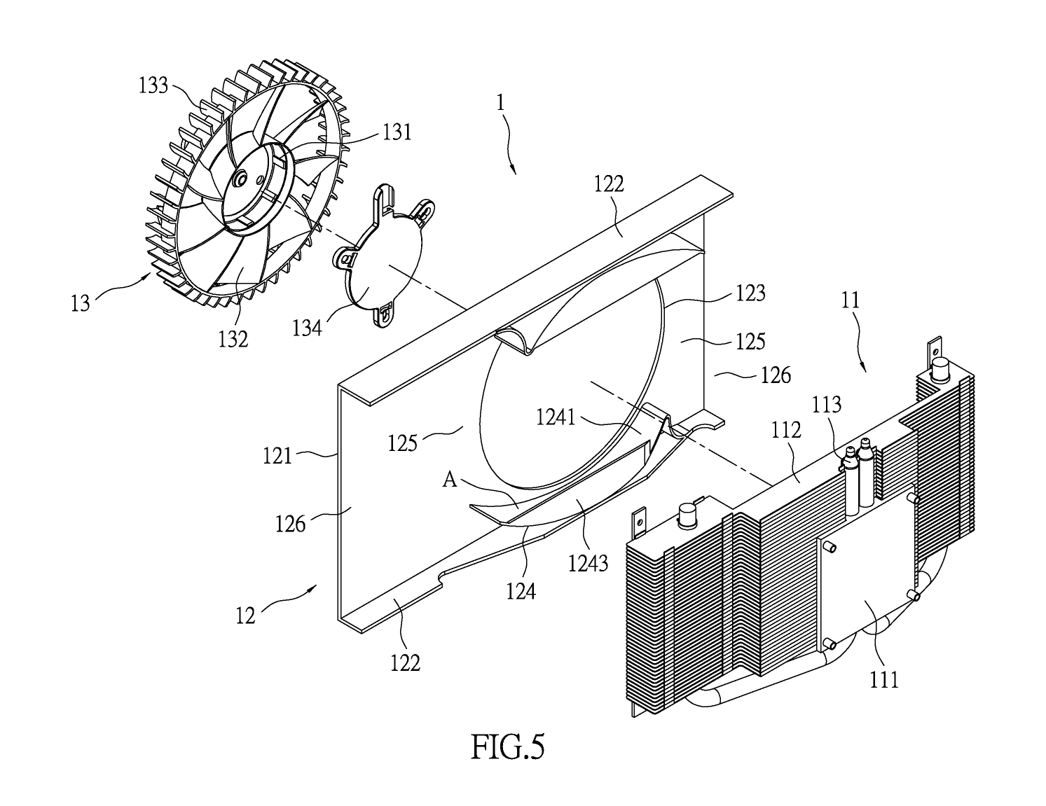

Please refer to FIGS. 4 and 5. Each protruding wall 124 in the instant embodiment has a curve panel 1241. At least portions of the curve panel 1241 and peripheral portions of the inlet opening 123 are not in parallel. In other words, at least portions of the curve panel 1241 have a pressing portion A arranged thereon. The pressing portion A gradually diverges from the peripheral portions of the inlet opening 123, such that the curve panel 1241 and the inlet opening 123 are not concentric. When air flows along the protruding wall 124 and is guided to exit through the opening 125, the air is pressurized, which can optimize air flow and heat dissipation.

### Third Embodiment

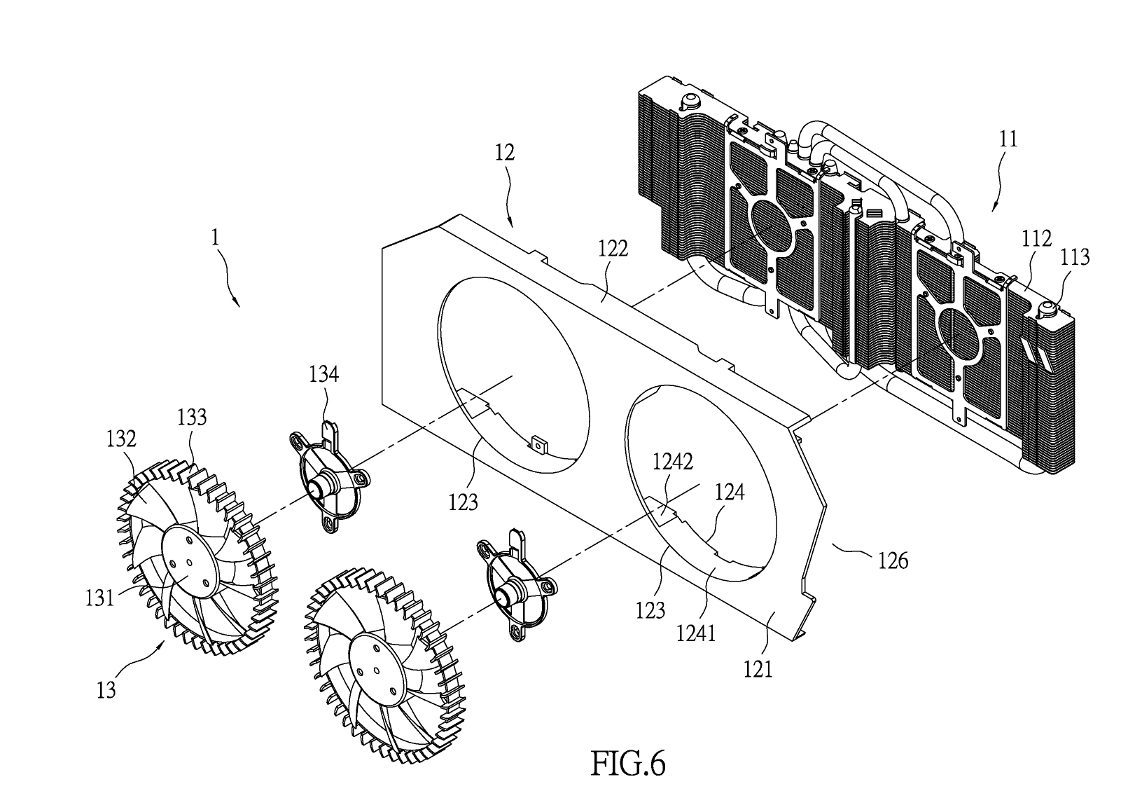

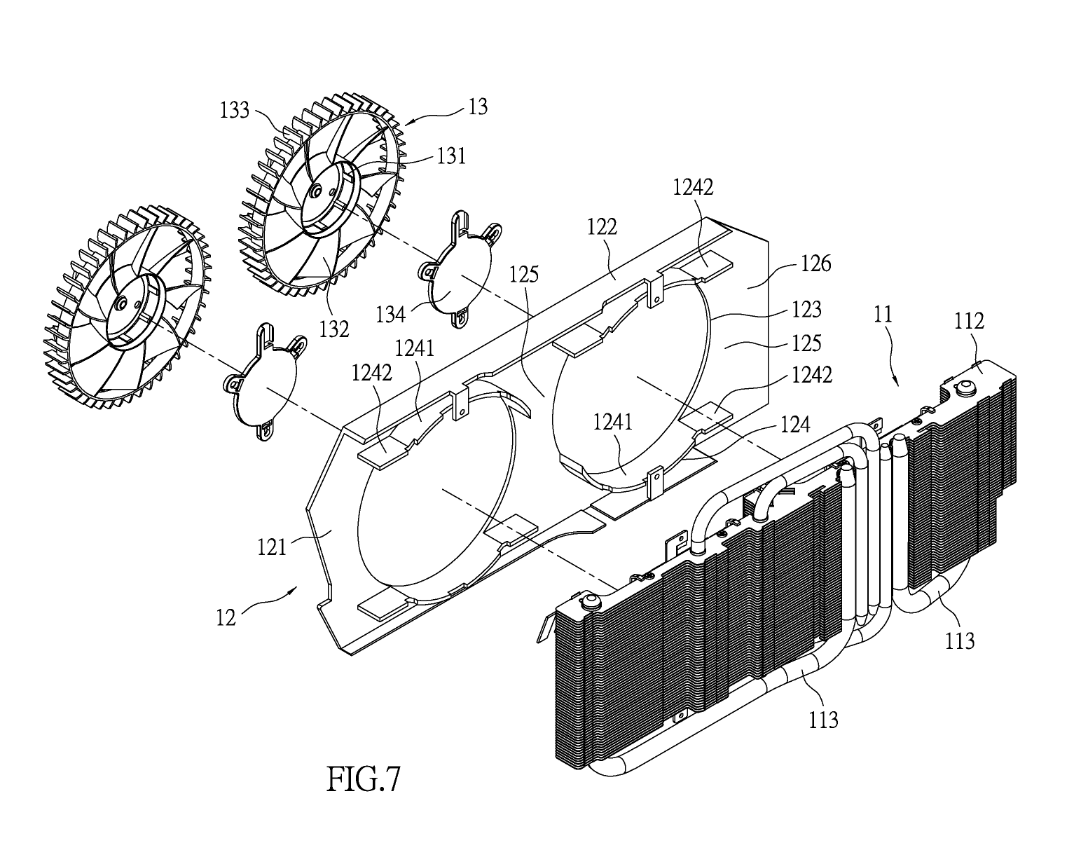

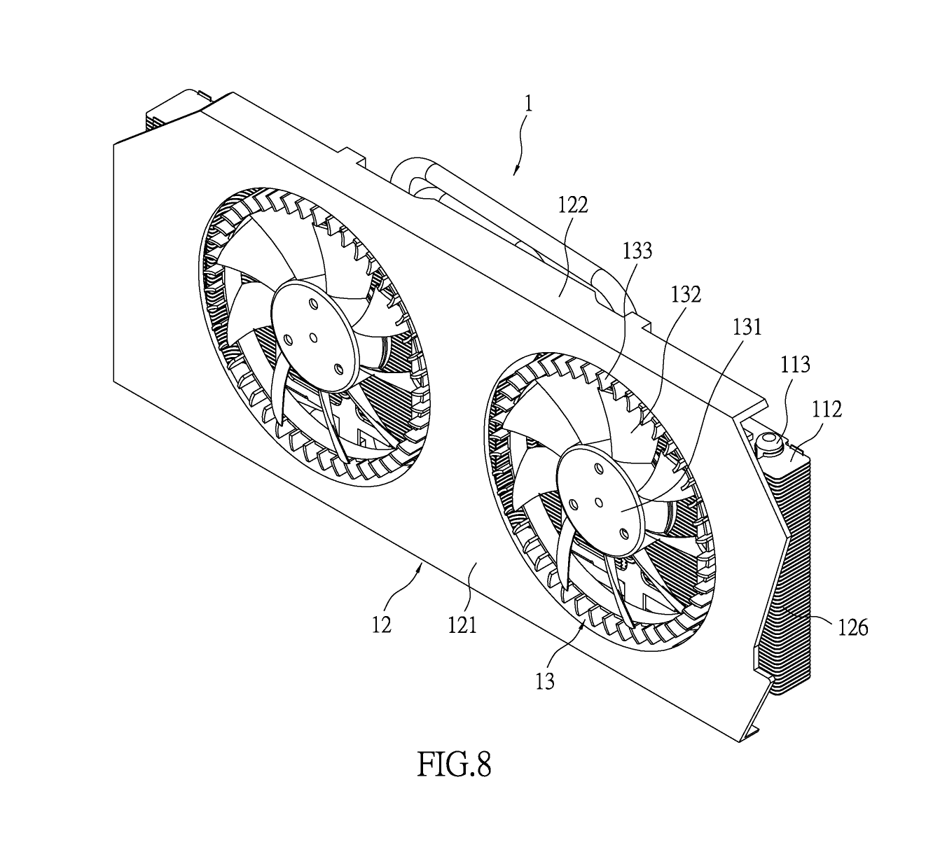

Please refer to FIGS. 6 to 8. The shape and structure of the heat sink 11 in the instant embodiment are different from previous embodiments. The heat dissipating device 1 in the instant embodiment omits the heat sink 11 and can be directly attached onto the heating element through heating pipes 113, such that the heat sink 11 and the heating element are in direct contact. Moreover, two fans 13 are provided in the instant embodiment. The housing 12 is correspondingly arranged with the two inlet openings 123. Each inlet opening 123 of the instant embodiment has two protruding walls 124 and two openings 125 arranged thereon. Two openings 125 are arranged between two ends of the two protruding walls 124. Each protruding wall 124 has a curve panel 1241 that extends along peripheral portions of the inlet opening 123. The curve panel 1241 and the inlet opening 123 can be concentric. Portions of two ends of the curve panel 1241 each have an end plate 1242 arranged thereon. The end plates 1242 and the two side plates 122 are parallel to each other. Portions of the curve panel 1241 have an end plate 1242 arranged on one end thereon, and the end plate 1242 is parallel to the two side plates 122. Two openings 125 located in the middle are arranged at a slanted angle in the instant embodiment. In other words, air can flow along the protruding walls 124 and is guided to slantedly exit via the openings 125.

### Fourth Embodiment

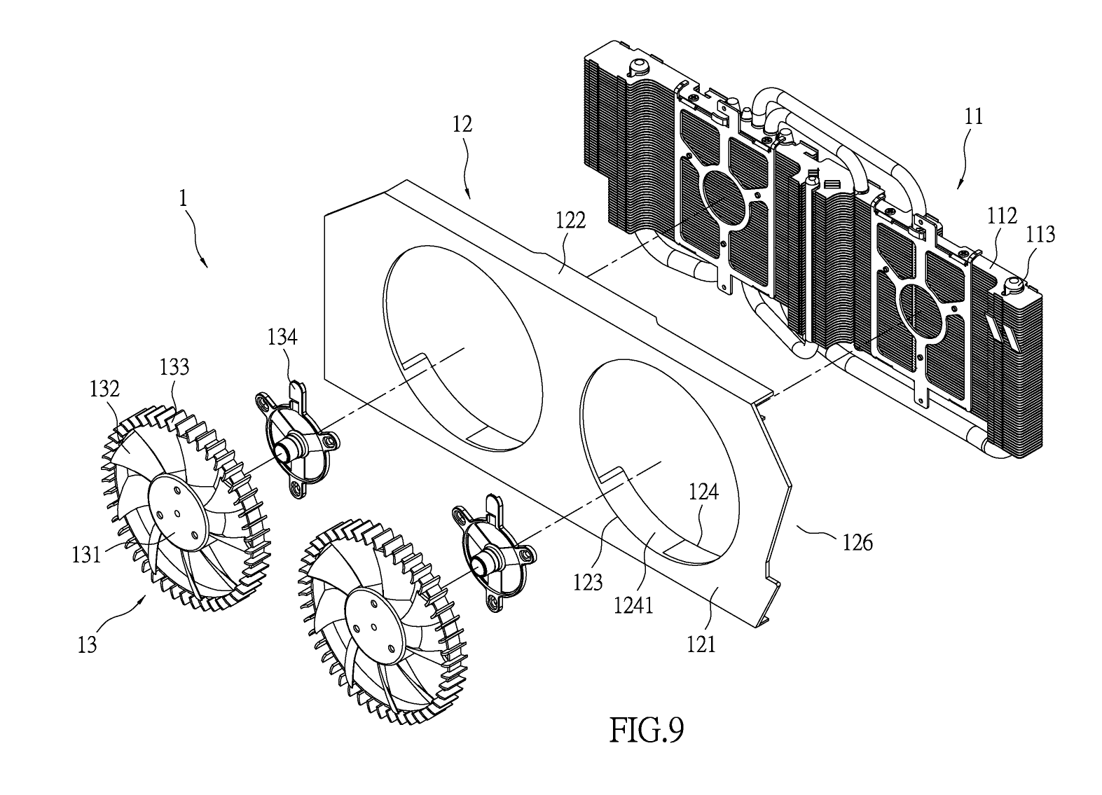

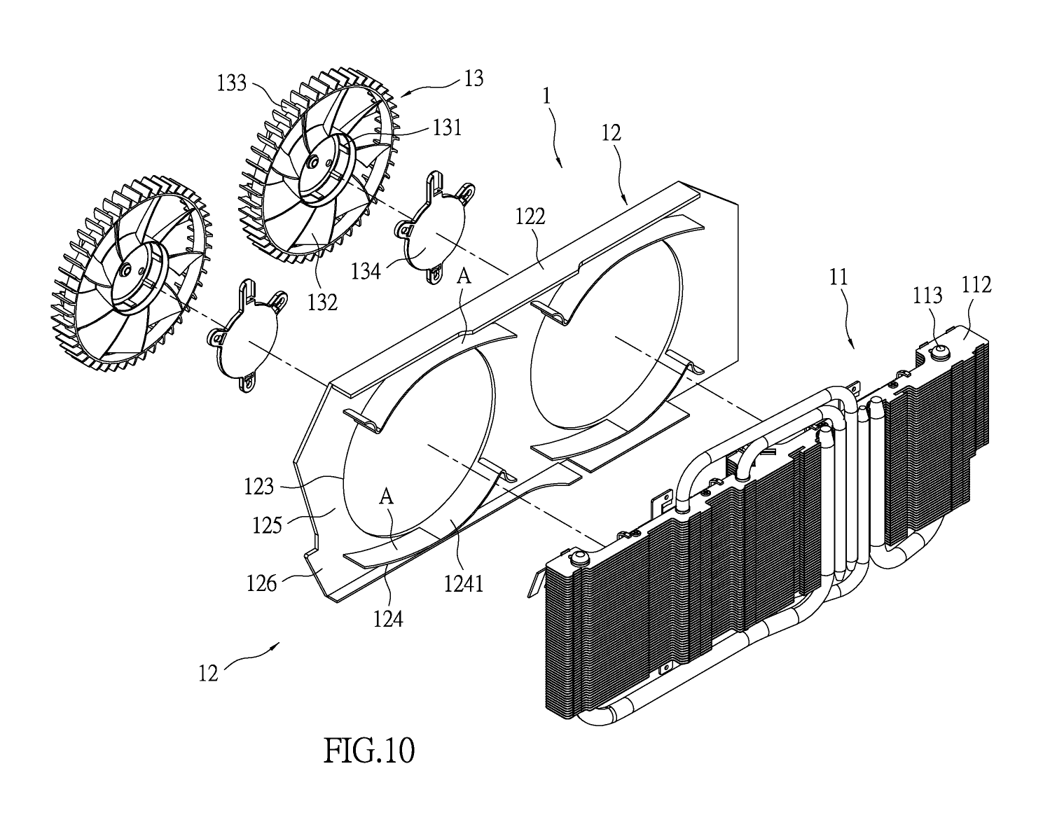

Please refer to FIGS. 9 and 10. Two fans 13 are provided in the instant embodiment. The housing 12 is correspondingly arranged with the two inlet openings 123. Each inlet opening 123 of the instant embodiment has two protruding walls 124 and two openings 125 arranged thereon. Two openings 125 are arranged between two ends of the two protruding walls 124. Each protruding wall 124 in the instant embodiment has a curve panel 1241. At least portions of the curve panel 1241 and peripheral portions of the inlet opening 123 are not in parallel. In other words, at least portions of the curve panel 1241 have a pressing portion A arranged thereon. The pressing portion A gradually diverges from the peripheral portions of the inlet opening 123, such that the curve panel 1241 and the inlet opening 123 are not concentric. When air flows along the protruding wall 124 and is guided to exit through the opening 125, the air is pressurized, which can optimize air flow and heat dissipation.

### Fifth Embodiment

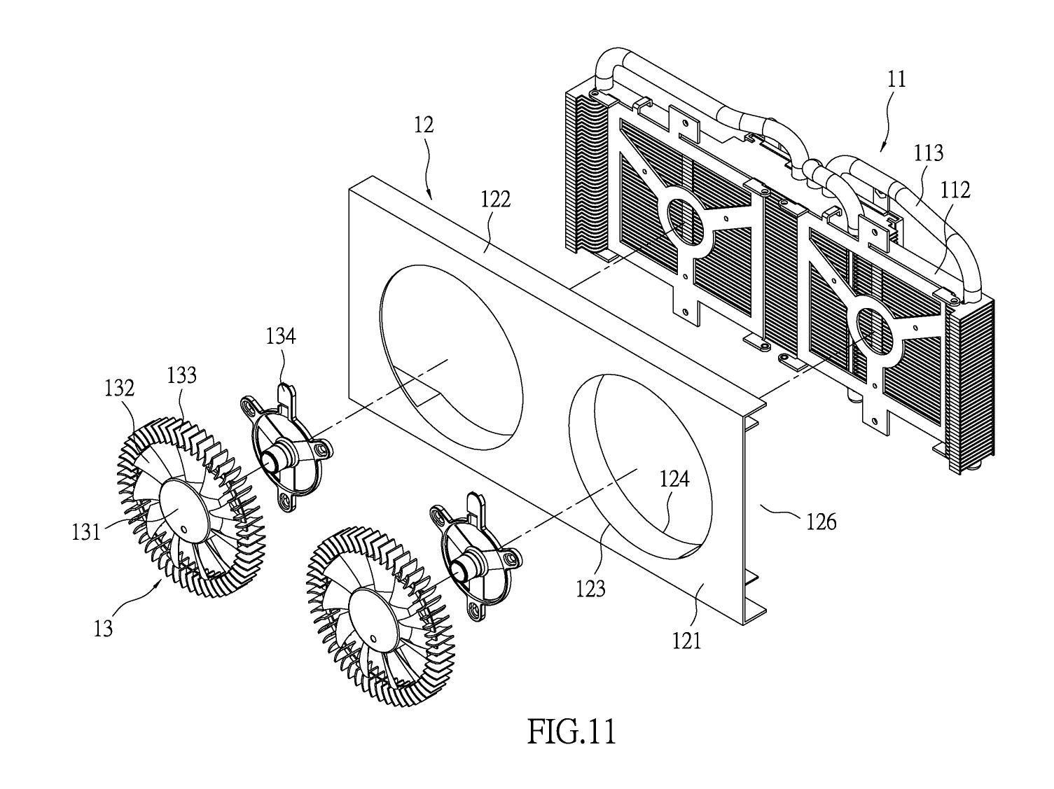

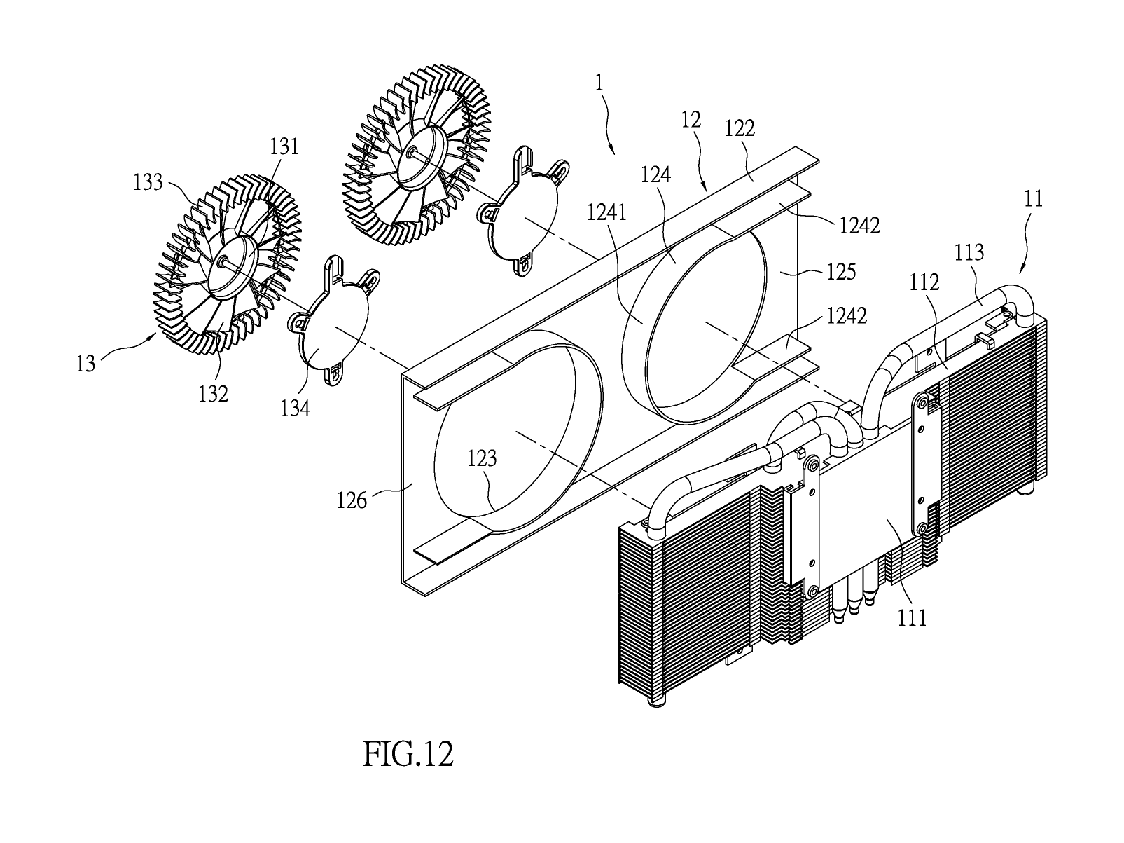

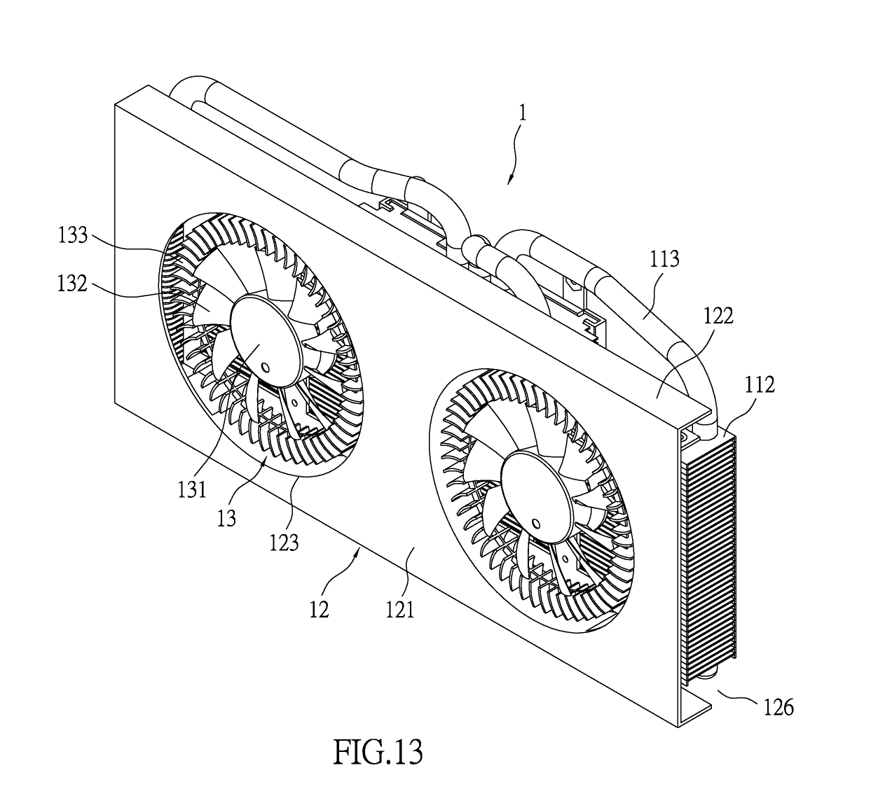

Please refer to FIGS. 11 to 13. Two fans 13 are provided in the instant embodiment. The housing 12 is correspondingly arranged with the two inlet openings 123. Each inlet opening 123 of the instant embodiment has one protruding wall 124 and one opening 125 arranged thereon. The protruding wall 124 is bent to resemble a U shape. The opening 125 is arranged between two ends of the protruding wall 124. The protruding wall 124 has a curve panel 1241 that extends along peripheral portions of the inlet opening 123. The curve panel 1241 and the inlet opening 123 can be concentric. Two ends of the curve panel 1241 each have an end plate 1242 arranged thereon. The opening 125 is arranged between the two end plates 1242. The end plates 1242 and the two side plates 122 are parallel to each other, so that air can be guided towards two sides of the housing 12.

### Sixth Embodiment

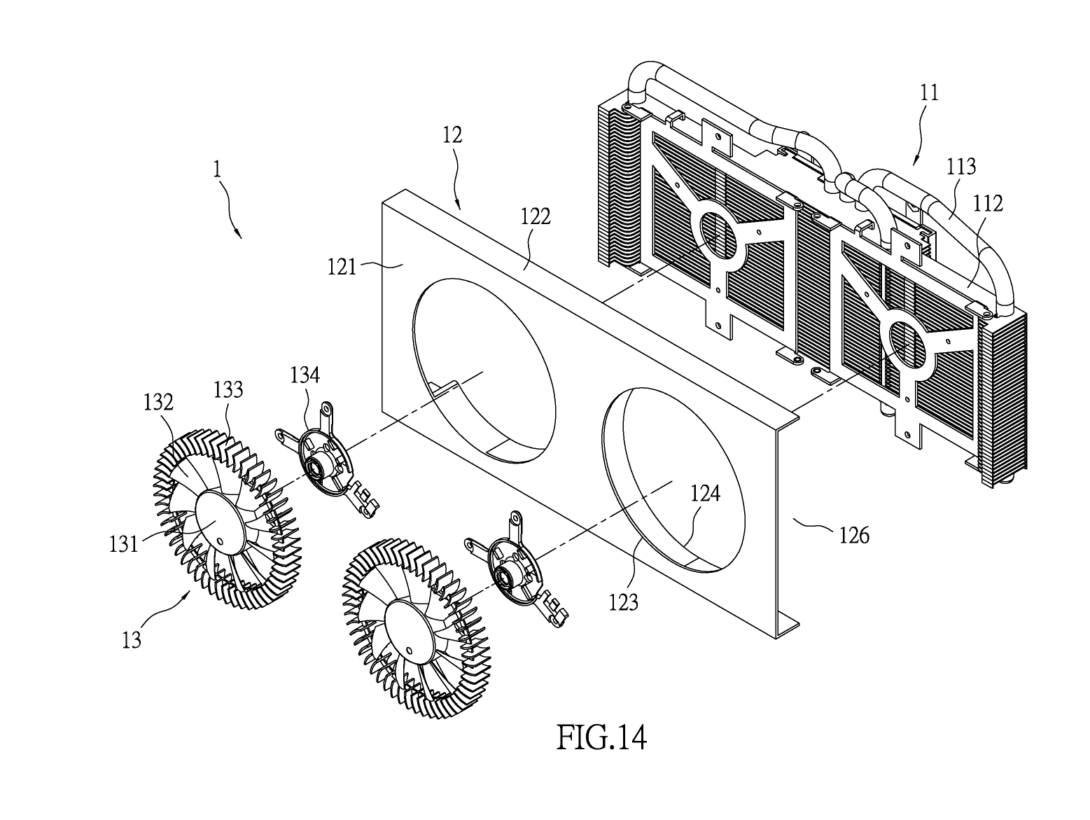

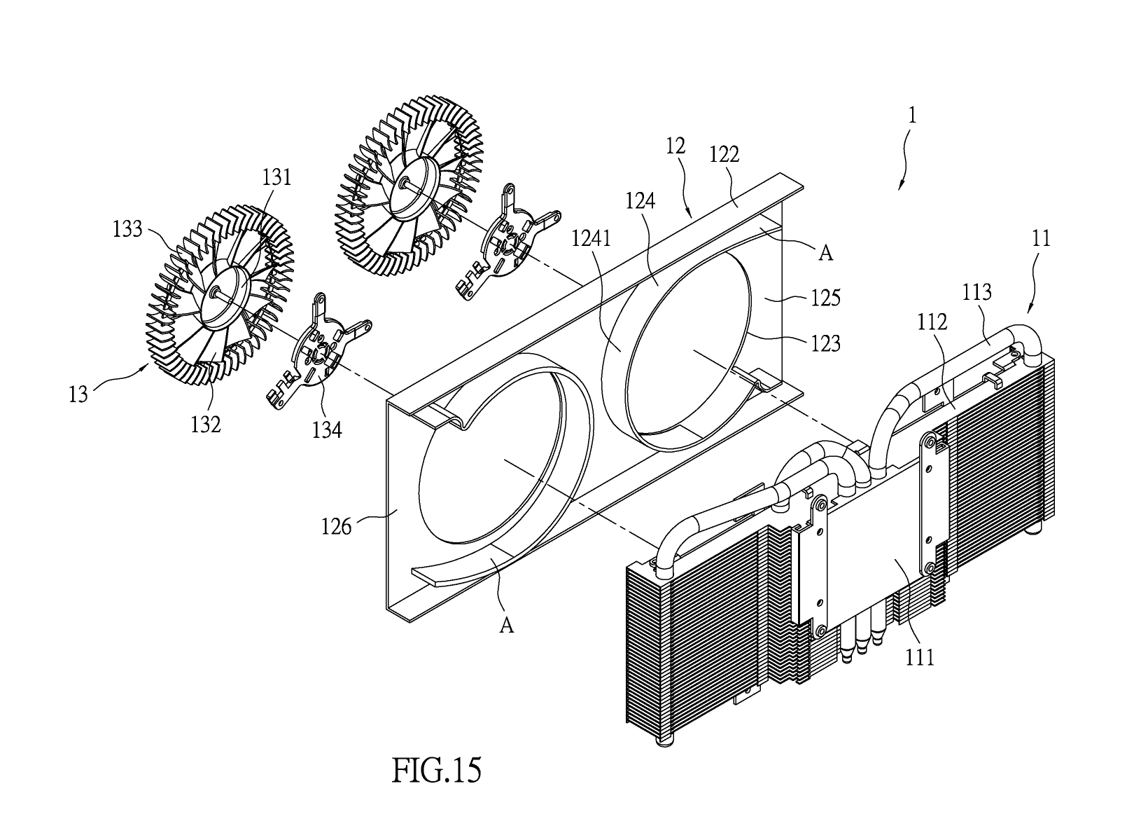

Please refer to FIGS. 14 and 15. Two fans 13 are provided in the instant embodiment. The housing 12 is correspondingly arranged with the two inlet openings 123. Each inlet opening 123 of the instant embodiment has one protruding wall 124 and one opening 125 arranged thereon. The protruding wall 124 is bent to resemble a U shape. The opening 125 is arranged between two ends of the protruding wall 124. The protruding wall 124 has a curve panel 1241. At least portions of the curve panel 1241 and peripheral portions of the inlet opening 123 are not in parallel. In other words, at least portions of the curve panel 1241 have a pressing portion A arranged thereon. The pressing portion A gradually diverges from the peripheral portions of the inlet opening 123, such that the curve panel 1241 and the inlet opening 123 are not concentric. When air flows along the protruding wall 124 and is guided to exit through the opening 125, the air is pressurized, which can optimize air flow and heat dissipation.

The fan in the instant disclosure is a composite fan, which provides both axial and centrifugal flow. The housing has a protruding wall and opening arranged thereon that can prevent unrestrained air flow as well as guide air to flow along the protruding wall and eventually towards the heat sink via the opening. The instant disclosure optimizes air flow, improves heat dissipation, and effectively improves heat dissipation efficiency.

Furthermore, the instant disclosure further provides protruding walls that include pressing portions on the housing. When air flows along the protruding walls and exits through the openings, the air is pressurized and the air flow is optimized to improve heat dissipation.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A heat-dissipating device for interface card disposed on an interface card, the interface card having a circuit board and a heating element disposed on the circuit board, the heat-dissipating device comprising:
a heat sink including a plurality of heat dissipating fins and a plurality of heat pipes, the heat sink is disposed on the interface card, and the heat sink in contact with the heating element;
a housing disposed on and covering the heat sink, the housing having a top plate and two side plates connected to two sides of the top plate, the top plate having an inlet opening arranged thereon, an inner surface of the top plate proximate to the inlet opening having a protruding wall and an opening arranged thereon, the protruding wall having a curve panel; and
a fan arranged in the housing and correspondingly arranged at the inlet opening, the fan having a rotational shaft, a plurality of axial fan blades, and a plurality of centrifugal fan blades, the axial fan blades connected to an outer edge of the rotational shaft, the centrifugal fan blades respectively connected to outer edges of the axial fan blades, the rotational shaft pivotally disposed on a bottom seat.

2. The heat-dissipating device for interface card as recited in claim 1, wherein the curve panel and the inlet opening are formed concentrically.

3. The heat-dissipating device for interface card as recited in claim 1, wherein the curve panel has two ends, each end has an end plate arranged thereon, the opening is arranged between the two end plates, the end plates and the two side plates are in parallel.

4. The heat-dissipating device for interface card as recited in claim 1, wherein the curve panel has a bottom portion connected to a bottom plate, the bottom plate and the top plate are in parallel.

5. The heat-dissipating device for interface card as recited in claim 1, wherein the curve panel has one pressing portion arranged on a portion thereof, the pressing portion gradually diverges from the peripheral portions of the inlet opening.

6. The heat-dissipating device for interface card as recited in claim 1, wherein one end of the curve panel has an end plate arranged thereon, the end plate and the two side plates are in parallel.

7. The heat-dissipating device for interface card as recited in claim 1, wherein the opening is arranged at a slanted angle.

8. The heat-dissipating device for interface card as recited in claim 1, wherein the protruding wall is bent to resemble a U shape.

9. The heat-dissipating device for interface card as recited in claim 1, wherein an inner surface of the top plate proximate to the inlet opening has two protruding walls and two openings, the two opposite protruding walls are arranged between the two side plates, the two openings are arranged between two ends of two protruding walls.

10. The heat-dissipating device for interface card as recited in claim 1, wherein the top plate has two outlet openings arranged between two ends of the two side plates.

11. The heat-dissipating device for interface card as recited in claim 1, wherein at least one fan is peripherally and conformingly arranged with at least one inlet opening.

12. A heat-dissipating device for interface card disposed on an interface card, the heat-dissipating device comprising:
a heat sink disposed on the interface card;
a housing disposed on and covering the heat sink, the housing having a top plate and two side plates connected to two sides of the top plate, the top plate having an inlet opening arranged thereon, an inner surface of the top plate proximate to the inlet opening having a protruding wall and an opening arranged thereon, the protruding wall having a curve panel; and
a fan arranged in the housing and correspondingly arranged at the inlet opening, the fan having a rotational shaft, a plurality of axial fan blades, and a plurality of centrifugal fan blades, the rotational shaft pivotally disposed on a bottom seat.

13. The heat-dissipating device for interface card as recited in claim 12, wherein the curve panel and the inlet opening are formed concentrically.

14. The heat-dissipating device for interface card as recited in claim 12, wherein the curve panel has two ends, each end has an end plate arranged thereon, the opening is arranged between the two end plates, the end plates and the two side plates are in parallel.

15. The heat-dissipating device for interface card as recited in claim 12, wherein the curve panel has a bottom portion connected to a bottom plate, the bottom plate and the top plate are in parallel.

16. The heat-dissipating device for interface card as recited in claim 12, wherein the curve panel has at least one pressing portion arranged thereon, the pressing portion gradually diverges from the peripheral portions of the inlet opening.

17. The heat-dissipating device for interface card as recited in claim 12, wherein one end of the curve panel has an end plate arranged thereon, the end plate and the two side plates are in parallel.

18. The heat-dissipating device for interface card as recited in claim 12, wherein the opening is arranged at a slanted angle.

19. The heat-dissipating device for interface card as recited in claim 12, wherein the protruding wall is bent to resemble a U shape.

20. The heat-dissipating device for interface card as recited in claim 12, wherein an inner surface of the top plate proximate to the inlet opening has two protruding walls and two openings, the two opposite protruding walls are arranged between the two side plates, the two openings are arranged between two ends of two protruding walls.

21. The heat-dissipating device for interface card as recited in claim 12, wherein the top plate has two outlet openings arranged between two ends of the two side plates.

22. The heat-dissipating device for interface card as recited in claim 12, wherein at least one fan is peripherally and conformingly arranged with at least one inlet opening.

23. A heat-dissipating device for interface card disposed on an interface card, the heat-dissipating device comprising:
a heat sink disposed on the interface card;
a housing disposed on and covering the heat sink, the housing having a top plate and two side plates connected to two sides of the top plate, the top plate having an inlet opening arranged thereon, an inner surface of the top plate proximate to the inlet opening having a protruding wall and an opening arranged thereon, the protruding wall having a curve panel; and
a fan arranged in the housing and correspondingly arranged at the inlet opening, the fan having a rotational shaft, a plurality of axial fan blades, and a plurality of centrifugal fan blades, the rotational shaft pivotally disposed on a bottom seat.

24. The heat-dissipating device for interface card as recited in claim 23, wherein the opening is arranged at a slanted angle.

25. The heat-dissipating device for interface card as recited in claim 23, wherein the protruding wall is bent to resemble a U shape.

26. The heat-dissipating device for interface card as recited in claim 23, wherein an inner surface of the top plate proximate to the inlet opening has two protruding walls and two openings, the two opposite protruding walls are arranged between the two side plates, the two openings are arranged between two ends of two protruding walls.

27. The heat-dissipating device for interface card as recited in claim 23, wherein the top plate has two outlet openings arranged between two ends of the two side plates.

28. The heat-dissipating device for interface card as recited in claim 23, wherein at least one fan is peripherally and conformingly arranged with at least one inlet opening.
